(19) United States
(12) Patent Application Publication
(10) Pub. No.: US 2004/0143711 A1
(43) Pub. Date: Jul. 22, 2004

(54) Mechanism to maintain data coherency for a read-ahead cache

(76) Inventors: Kimming So, Palo Alto, CA (US); Hon-Chong Ho, San Jose, CA (US)

Correspondence Address: MCANDREWS HELD & MALLOY, LTD, 500 WEST MADISON STREET, SUITE 3400, CHICAGO, IL, 60661

(21) Appl. No.: 10/745,155

(22) Filed: Dec. 23, 2003

Related U.S. Application Data
(63) Continuation-in-part of application No. 10/294,539, filed on Nov. 14, 2002.
(63) Continuation-in-part of application No. 10/294,091, filed on Nov. 14, 2002.
(63) Continuation-in-part of application No. 10/294,415, filed on Nov. 14, 2002.
(60) Provisional application No. 60/409,256, filed on Sep. 9, 2002.
(60) Provisional application No. 60/409,240, filed on Sep. 9, 2002.
(60) Provisional application No. 60/409,361, filed on Sep. 9, 2002.
(60) Provisional application No. 60/409,256, filed on Sep. 9, 2002.
(60) Provisional application No. 60/409,240, filed on Sep. 9, 2002.
(60) Provisional application No. 60/409,361, filed on Sep. 9, 2002.
(60) Provisional application No. 60/409,256, filed on Sep. 9, 2002.
(60) Provisional application No. 60/409,240, filed on Sep. 9, 2002.
(60) Provisional application No. 60/409,361, filed on Sep. 9, 2002.
(60) Provisional application No. 60/487,439, filed on Jul. 15, 2003.

(51) Int. Cl. G06F 12/08

(52) U.S. Cl. 711/144; 711/133; 711/137

(57) ABSTRACT

One or more methods and systems of maintaining data coherency of a read-ahead cache are presented. Blocks may be invalidated, for example, when a data coherency scheme is implemented by a multiprocessor based system. In one embodiment, the read-ahead cache may receive invalidate requests by way of cache control instructions generated from an execution unit of a control processor. In one embodiment, one or more blocks are invalidated in the read-ahead cache when one or more cache lines are modified in a data cache. In one embodiment, the method comprises using a read-ahead cache controller to perform one or more invalidation actions on the read-ahead cache.

### BACKGROUND OF THE INVENTION

As applications become complex enough to require the use of multiprocessors, the use of multiple cache levels to speed up processing tasks performed by central processing units (CPUs) or control processors may be implemented over an architecture that shares a common main memory. The processors may share the main memory with other processors by way of a memory controller. The sharing of the main memory, however, may pose a number of data coherency issues, as one or more processors modify data stored in main memory.

In an embedded multiprocessor based system, data from main memory is often shared between a number of processors (e.g., CPUs). In many instances, a processor's cache memory is updated based on data stored in the main memory. Since some data is used more frequently than others, one or more processor cache memories may load such frequently used data from main memory. Such cache memories, for example, may contain inconsistent data over time as new data is updated in one processor's cache memory and not in another processor's cache memory. This may cause processing problems for one or more processors if the data is modified in one processor's cache memory without appropriately updating the modification to other memories (e.g., cache memories) located within the other processors. As a consequence, one or more cache memories may need to be updated as a result of a modification. If updates are not made, invalid data may be used by the one or more processors during subsequent execution of instructions. In many instances, a software data coherency scheme is applied as opposed to a hardware data coherency scheme, in order to update a stale or invalid cache line from a processor's memory cache.

In many instances, the processor caches may comprise prefetch or read-ahead type of caches that seamlessly operate in the background, providing blocks of data to its associated processor. As a result, processing may be performed more efficiently since the data is located close to the processor in anticipation that the processor may use the data in the near future. Since a number of cache lines are usually stored or accessed from a read-ahead cache by way of larger units called data blocks, it is often difficult to identify and modify the individual cache lines. Hence, it may be difficult for the software in a software data coherency scheme to identify which pre-fetch or read-ahead cache's data blocks have been modified by a remote processor. This often results in difficulty ascertaining which cache lines stored in the read-ahead cache are affected. Hence, these data blocks may be undesirable for subsequent use and must be invalidated or removed.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be found in a system and method to invalidate one or more blocks of a read-ahead cache (RAC). The RAC is part of a shared memory based multiprocessor system. In one embodiment, a method of maintaining data coherency of a read-ahead cache comprises executing cache control instructions generated by an execution unit of a control processor, generating a cache line invalidate request, receiving a read-ahead cache controller invalidate request by a read-ahead cache controller and transmitting a read-ahead cache invalidate request to the read-ahead cache. In one embodiment, the cache controller comprises a data cache controller or an instruction cache controller. In one embodiment, cache invalidate instructions are defined by a MIPS instruction set architecture. These cache invalidate instructions are used to remove a cache line from a cache memory. In one embodiment, the read-ahead cache controller invalidate request comprises a memory address and cache identifier for use in the read-ahead cache. In one example, the read-ahead cache controller invalidate request comprises a specific action to be performed on the read-ahead cache. For example, the action may comprise invalidating a number of blocks or invalidating all blocks of the read-ahead cache.

Additional aspects of the present invention may be found in a method of performing actions on a read-ahead cache comprising implementing one or more control registers in a read-ahead cache controller, assigning a number of bits to a first control register corresponding to the number of actions performed on the read-ahead cache, assigning an action to one or more permutation of bits in the first control register, assigning a number of bits to a second control register corresponding to an identifier of blocks within the read-ahead cache.

Other aspects of the present invention may be found in a method of maintaining data coherency of a read-ahead cache by executing instructions by an execution unit, transmitting one or more requests to a cache controller based on the instructions, updating contents of a cache associated with the cache controller, generating a read-ahead cache hits associated with the data previously replaced and/or modified in cache, and invalidating one or more blocks in said read-ahead cache associated with the read-ahead cache hits.

In one embodiment, a system is presented that maintains data coherency of a read-ahead cache which comprises an execution unit of a control processor that generates a cache line invalidate request, a cache memory controller that receives the cache invalidate request and generates a read-ahead cache controller invalidate request, a read-ahead cache controller that receives the read-ahead cache controller invalidate request and generates a read-ahead cache invalidate request.

In an additional embodiment, a system of maintaining data coherency of a read-ahead cache is presented that comprises a read-ahead cache controller that generates one or more read-ahead cache invalidate requests to the read-ahead cache. In one embodiment, the read-ahead cache controller comprises one or more control registers that define an address or location of blocks in said read-ahead cache or an action performed on said read-ahead cache.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a generic block diagram of a multiprocessor based system employing a read-ahead cache in accordance with an embodiment of the invention.

FIG. 2 is a relational block diagram of a multiprocessor based system that illustrates signals used in invalidating blocks of a read-ahead cache (RAC) in accordance with an embodiment of the invention.

### DETAILED DESCRIPTION OF THE INVENTION

Aspects of the present invention may be found in a system and method to invalidate one or more blocks of a read-ahead cache (RAC) memory. One or more data blocks may be invalidated in a RAC, for example, when a software based data coherency scheme is implemented by a multiprocessor system. In one embodiment, the software based data coherency scheme comprises invalidating one or more blocks of one or more read-ahead caches when a write is performed into a cache memory of a control processor within the multiprocessor system. The RAC may receive invalidate requests from an execution unit of a control processor by way of one or more cache controllers. In one embodiment, the invalidate requests may be implemented as a combination of one or more hardware communication protocols and software instructions. The software instructions may be provided by execution of a software program or application. In one embodiment, the cache controllers comprise a data cache controller or an instruction cache controller. In one embodiment, the requests may comprise requests generated by a MIPS instruction set architecture.

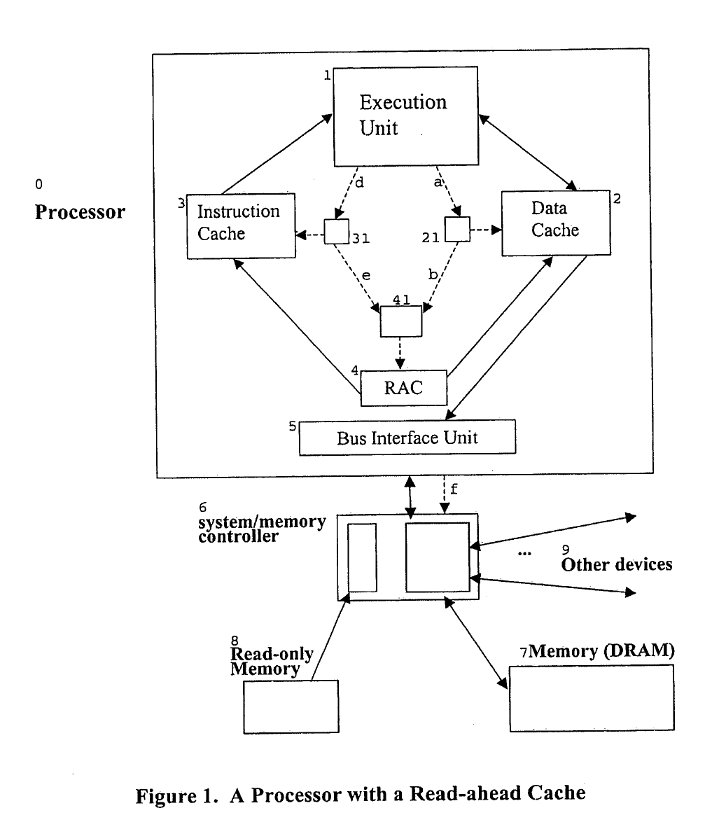

FIG. 1 is a generic block diagram of a multiprocessor based system employing a read-ahead (RAC) cache 4 in accordance with an embodiment of the invention. The RAC 4 may comprise a pre-fetch cache. For purposes of convenience, details pertaining to a single processor 0 of the multiprocessor based system is illustrated. The processor 0 shown comprises an execution unit 1, its associated level 1 data and instructional cache 2, 3, its associated level 1 data and instructional cache controllers (or associated load and store units) 21, 31, its associated read-ahead cache (RAC) 4, its associated read-ahead cache controller 41, and bus interface unit 5 is illustrated. As shown, the processor 0 communicates to a memory which comprises a dynamic random access memory (DRAM) 7 in this embodiment. The processor communicates to a read-only memory (ROM) 8 by way of a system/memory controller 6. The processor 0 interfaces with the system/memory controller 6 by way of its bus interface unit 5. As illustrated in FIG. 1, there may be other devices 9 that communicate with the system/memory controller 6. These other devices 9 may comprise input/output (I/O) devices or one or more additional processors. It is understood that the processor 0 as well as the other devices 9 may share the DRAM 7 or ROM 8.

The processor 0 comprises an execution unit 1 used to execute software programs and/or applications. In addition, the processor 0 comprises a data cache 2 and an instruction cache 3 that serve as high speed buffers for the DRAM 7 and ROM 8. It is assumed all data accessed by the processor 0 from the DRAM 7 and ROM 8 are cacheable. For example, a processor may operate on a portion of data by way of accessing a segment of memory, termed a cache line or line. When the cache line is received by the processor 0, the portion of data is transmitted to the execution unit 1 for processing; thereafter, the remaining data in the cache line is saved in the data cache 2 for near future use.

As shown in FIG. 1, a readahead cache (RAC) 4 may be employed to facilitate faster access to certain data or instructions most readily utilized by the processor 0. The RAC 4 facilitates access to readily used data by the processor 0. Data stored in the RAC 4 is organized in units termed blocks while data stored in cache is organized in terms of lines of cache.

A processor may issue a request to memory (DRAM or ROM) 7, 8 to access a particular data. In one embodiment, the data is accessed by way of requests made by a cache controller 21 for accessing the data cache 2. In order to access the data, an appropriate address, a (as illustrated in FIG. 1), is provided to the cache controller 21 by the execution unit 1. If the data is provided by the data cache, the data is transmitted to the execution unit 1 for processing. Otherwise, a data cache miss message, b, is transmitted to the RAC controller 41. Should the RAC 4 receive the data cache miss message, b, while the requested data resides in the RAC 4, the RAC 4 supplies the data requested by the execution unit 0 to the data cache 2. Otherwise, a RAC request, f, is generated to the system/memory controller 6. The system/memory controller 6 may query the contents of memory (DRAM or ROM) 7, 8 in order to access the requested data. If the requested data is filled from memory 7, 8, the associated block is filled into the RAC 4. Subsequently, the corresponding line in the data cache 2 is filled from the filled block in RAC 4. Note that the RAC 4 may send out one or more RAC requests (e.g., block requests), f. Each block may contain multiple cache lines.

Similarly, a data request related to instruction fetches may be performed by way of an appropriate address, d, provided by the execution unit 1 to an instruction cache controller 31. If the data exists at the instruction cache 3, the data is transmitted to the execution unit 1 for processing. Otherwise, an instruction cache miss message, e, is generated and sent to the RAC controller 41. If the RAC 4 receives the instruction cache miss message, e, the RAC supplies the data requested by the execution unit 0 to the instruction cache 3. Again, if the RAC 4 is unable to supply the requested data, a RAC request, f, is generated to the system/memory controller 6. The system/memory controller 6 may query the contents of memory (DRAM or ROM) 7, 8 in order to access the requested data. If the requested data is filled from memory 7, 8, the associated block is filled into the RAC 4. Subsequently, the corresponding line in the instruction cache 3 is filled from the filled block in RAC 4.

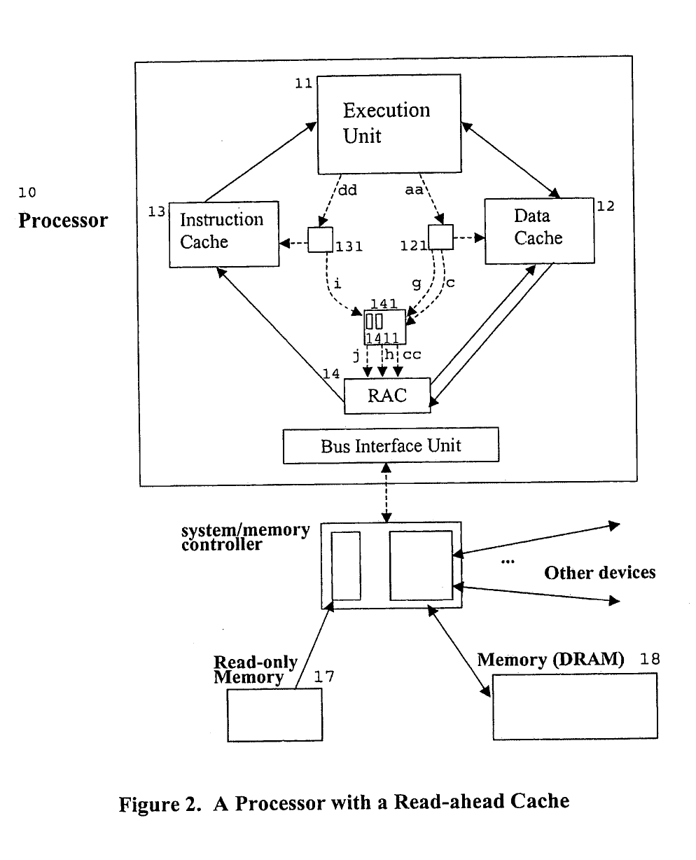

FIG. 2 is a relational block diagram of a multiprocessor based system that illustrates signals used in invalidating blocks of a read-ahead cache (RAC) 14 in accordance with an embodiment of the invention. The RAC 14 may comprise a pre-fetch cache. In one embodiment, the RAC 14 comprises a level 2 or level 3 type cache. In one embodiment, instructions are decoded by an instruction decoder located within the execution unit 11. The instruction decoder may comprise circuitry used to decode the instructions. In one embodiment, the instructions comprise cache control instructions defined by a MIPS instruction set architecture. For example, the cache control instructions may comprise a cache line invalidate instruction such as a hit invalidate, an index invalidate, or a store tag instruction. The hit invalidate instruction may instruct the data or instruction cache controller 121, 131, to invalidate a particular line of cache within the data or instruction cache 12, 13, when a particular cache line is found. Similarly, the index invalidate signal may instruct a data or instruction cache controller 121, 131, to invalidate one or more cache lines in a particular location of cache 12, 13. In one embodiment, the data or instruction cache 12, 13 may comprise a level 1 cache.

In one embodiment, a cache line invalidate request, aa, is generated by the execution unit 11 of the processor 10 to facilitate invalidation of cache lines in the data and/or instruction cache 12, 13. The cache line invalidate request, aa, may initiate the generation of a read-ahead cache controller invalidate signal, g, used by the read-ahead cache controller 141, to invalidate one or more blocks of memory in an associated read-ahead cache 14. The read-ahead cache controller invalidate request, g, is generated by a cache controller such as a data cache controller 121 or instruction cache controller 131, shown in FIG. 2. The read-ahead cache controller invalidate request, g, may be generated as a response to the cache line invalidate request, aa, being received by the cache controllers 121, 131. The read-ahead cache controller invalidate request, g, is transmitted to the RAC controller 141. Upon receiving the read-ahead controller invalidate request, g, by the RAC controller 141, the RAC controller 141 facilitates the invalidation of a number of RAC block(s) in a RAC 14. In one embodiment, the read-ahead cache controller invalidate request, g, initiates transmission of a read-ahead cache invalidate request, h, from the read-ahead cache controller 141 to the read-ahead cache 14. The read-ahead cache invalidate request, h, may selectively invalidate one or more blocks within the read-ahead cache 14. In one embodiment, the read-ahead cache invalidate request, h, may selectively invalidate all blocks within the read-ahead cache 14.

Similarly, it is contemplated that the steps described above for invalidating one or more blocks within the read-ahead cache 14 may be accomplished by way of a cache invalidate request, dd, transmitted to the instruction cache 13. An associated read-ahead cache controller invalidate request, i, as well as read-ahead cache invalidate request, j, may be generated to invalidate one or more blocks of the read-ahead cache 14. In one embodiment, the cache invalidate request (aa or dd) and/or the read-ahead cache controller invalidate request (i or g) comprises a) a cache identifier such as information related to the type of cache 12, 13 (i.e., data or instruction cache) the request is associated with, b) the addresses to be invalidated in memory, and c) one or more action(s) to be performed at the read-ahead cache 14. Although the RAC 14 is configured as an on-chip cache as shown in FIGS. 1 and 2, in one embodiment, the RAC 14 is configured as an off-chip cache. The read-ahead cache controller 141 may comprise a number of control registers (CR) 1411 that contain bits used to selectively determine what actions will be performed on the read-ahead cache (RAC) 14.

The following table illustrates the relationships of data in control registers 1411 and their corresponding actions on a read-ahead cache (RAC) 14 in accordance with an embodiment of the invention:

TABLE 1

| | bits[2:0] | bits[31:0] | |
|---|---|---|---|
| Action | in CR0 | in CR1 | Actions at RAC |
| invalidate block | 001 | memory | lookup RAC with the |
| corresponding to | | address of | address, invalidate it if |
| memory address | | the block | found |
| designated by bits [31:0] | | | |
| invalidate block | 010 | location | invalidate the block in |
| corresponding to | | in RAC | the location of the |
| location designated by | | | RAC |
| bits [31:0] | | | |
| invalidate all RAC | 011 | — | invalidate all RAC |
| blocks | | | blocks |

As illustrated in the table, a number of invalidate actions may be performed at the RAC 14 depending upon on the bit configuration of an exemplary 32 bit address stored in the control registers 1411. For example, the control registers 1411 may comprise two control registers termed CR0 and CR1 as shown in the table. CR0 may comprise a 3-bit block corresponding to bits 0 through 2. The three bits of CR0 may be used to indicate the type of action performed on the RAC 14. CR1 may comprise a 32-bit block address corresponding to bits 0 through 31. For example, if CR0 contains the values (001), the action that is taken by the RAC controller 141 corresponds to searching for the address indicated in CR1 within the RAC 14 and invalidating the block that corresponds to the address found. In another example, if CR0 contains the values (010), the action that is taken by the RAC controller 141 corresponds to identifying a location (e.g., row and column coordinates) within the RAC 14 and subsequently invalidating the block corresponding to that location. In another example, if CR0 contains the values (011), the action that is taken by the RAC controller 141 corresponds to invalidating all blocks in the associated RAC 14. The embodiment described in Table 1 is exemplary, as the number of bits may be appropriately assigned to CR0 and CR1 based on a particular implementation.

In one embodiment of the present invention, the processor 10, by way of its execution unit 11, will perform a data store into one or more of its registers. For example, processing that is performed by the execution unit 11 may update contents of the data cache 12. Appropriate instructions executed by the execution unit 11 may result in one or more associated requests that are transmitted to the data cache controller 121 in order to update the contents of the data cache 12 and memories 17, 18. The requests received by the data cache controller 121 initiate a replacement of one or more cache lines stored in the data cache 12. For example, one or more cache line(s) may be updated (i.e., modified and/or replaced) from the data cache based on addresses provided by the requests. In one embodiment, one or more blocks associated with the modified and/or replaced cache line(s) are identified by way of a read-ahead cache controller invalidate request, such as signal c, that is transmitted to the read-ahead cache controller 141 by way of a data cache controller 121. The read-ahead cache controller invalidate request, c, facilitates the generation of a read-ahead cache invalidate request, cc. In one embodiment, the read-ahead cache invalidate request, cc, determines if the RAC 14 contains any data that corresponds to the data updated in the data cache 12. After identifying one or more blocks corresponding to the data updated in the data cache 12, the one or more blocks in the RAC 14 are invalidated. For example, the read-ahead cache controller invalidate request, c, may generate a cache hit of the read-ahead cache 14 that corresponds to the data that was modified in the data cache 12. As a result, the identified blocks in read-ahead cache 14 are invalidated and will no longer be available. Such invalidated data would need to be fetched from main memory if it is subsequently used by the processor 10.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of maintaining data coherency of a read-ahead cache comprising:
executing cache control instructions generated by an execution unit of a control processor; and
receiving a read-ahead cache invalidate request by said read-ahead cache.

2. The method of claim 1 wherein said read-ahead cache comprises a pre-fetch cache located between a processor cache and main memory.

3. The method of claim 2 wherein said processor cache comprises a level 1 cache memory.

4. The method of claim 2 wherein said read-ahead cache comprises a level 2 or level 3 cache memory.

5. The method of claim 1 further comprising:
transmitting a cache line invalidate request to a cache controller from said execution unit;
invalidating one or more cache lines in a cache determined by said cache line invalidate request; and
generating a read-ahead cache controller invalidate request by said cache controller.

6. The method of claim 5 wherein said cache comprises a data cache or an instruction cache.

7. The method of claim 1 wherein said cache control instructions are defined by a MIPS control processor instruction set architecture.

8. A method of maintaining data coherency of a read-ahead cache comprising:
executing cache control instructions generated by an execution unit of a control processor;
generating a cache line invalidate request;
receiving a read-ahead cache controller invalidate request by a read-ahead cache controller; and
transmitting a read-ahead cache invalidate request to said read-ahead cache.

9. The method of claim 8 wherein said cache control instructions comprises a cache line invalidate instruction.

10. The method of claim 8 further comprising:
transmitting said cache line invalidate request to a cache controller from said execution unit; and
generating said read-ahead cache controller invalidate request by said cache controller.

11. The method of claim 10 wherein said cache controller comprises a data cache controller.

12. The method of claim 8 wherein said read-ahead cache controller invalidate request comprises a memory address and a cache identifier.

13. The method of claim 12 wherein said read-ahead cache controller invalidate request further comprises data that selects an invalidation action performed by said read-ahead cache.

14. The method of claim 13 wherein said invalidation action comprises invalidating one or more blocks within said read-ahead cache.

15. The method of claim 13 wherein said invalidation action comprises invalidating all blocks within said read-ahead cache.

16. The method of claim 8 wherein said cache control instructions comprises an index invalidate instruction.

17. The method of claim 8 wherein said cache control instructions comprises a hit invalidate instruction.

18. The method of claim 8 wherein said cache control instructions comprises a store tag instruction.

19. The method of claim 8 wherein said read-ahead cache invalidate request facilitates invalidation of one or more blocks of said read-ahead cache.

20. The method of claim 8 wherein said read-ahead cache invalidate request facilitates invalidation of all blocks contained within said read-ahead cache.

21. The method of claim 8 wherein said read-ahead cache invalidate request is generated by way of one or more control registers implemented in a read-ahead cache controller.

22. A method of invalidating blocks on a read-ahead cache comprising:
implementing a first control register in a read-ahead cache controller to identify a block within said read-ahead cache; and
implementing a second control register of said read-ahead cache controller to select an action performed on said identified block.

23. A method of maintaining data coherency of a read-ahead cache comprising:
executing instructions by an execution unit;
transmitting one or more requests to a cache controller based on said instructions;
updating contents of a cache associated with said cache controller;
generating read-ahead cache hits associated with the data previously replaced and/or modified in cache; and
invalidating one or more blocks in said read-ahead cache associated with said read-ahead cache hits.

24. A system of maintaining data coherency of a read-ahead cache comprising:
an execution unit of a control processor that generates a cache line invalidate request;
a cache memory controller that receives said cache invalidate request and generates a read-ahead cache controller invalidate request; and
a read-ahead cache controller that receives said read-ahead cache controller invalidate request and generates a read-ahead cache invalidate request.

25. The system of claim 24 further comprising a cache memory that receives said cache line invalidate request and invalidates one or more cache lines in said cache memory.

26. A system of maintaining data coherency of a read-ahead cache comprising a read-ahead cache controller that generates one or more read-ahead cache invalidate requests to said read-ahead cache.

27. The system of claim 26 wherein said read-ahead cache controller comprises one or more control registers.

28. The system of claim 27 wherein a control register of said one or more control registers comprises a number of bits that define an address or location of blocks in said read-ahead cache.

29. The system of claim 27 wherein a control register of said one or more control registers comprises a number of bits that define an action performed on said read-ahead cache.
